(19) United States
(12) Patent Application Publication
(10) Pub. No.: US 2014/0224119 A1
(43) Pub. Date: Aug. 14, 2014

(54) METHOD OF REMOVING ABSORBATES FROM GASES OR GAS MIXTURES CONTAINING ABSORBATE UTILIZING MISCIBILITY GAPS

(71) Applicant: Steffen Kujath, Domat/Ems (CH)

(72) Inventor: Steffen Kujath, Domat/Ems (CH)

(73) Assignee: Uhde Inventa-Fischer GmbH, Berlin (DE)

(21) Appl. No.: 13/762,425

(22) Filed: Feb. 8, 2013

(51) Int. Cl. B01D 53/14

(52) U.S. Cl. CPC B01D 53/1487
USPC 95/46; 95/149; 95/237; 95/239; 95/173; 95/156; 95/174

(57) ABSTRACT

The present invention relates to a method of removing an absorbate from gases or gas mixtures containing absorbate, in which the gas or gas mixture is contacted by a liquid mixture of absorption agent and absorbate or of liquid absorbate-free absorption agent, wherein the absorbate is absorbed at least partially by the liquid mixture of absorption agent and absorbate and is concentrated therein or is absorbed by the liquid absorbate-free absorption agent while forming a liquid mixture of absorption agent and absorbate. It is characteristic in the method in accordance with the present invention that the absorption agent used and the absorbate used have a miscibility gap.

### TECHNICAL FIELD

The present invention relates to a method of removing an absorbate from gases or gas mixtures containing absorbate, in which the gas or gas mixture is contacted by a liquid mixture of absorption agent and absorbate or of liquid absorbate-free absorption agent, wherein the absorbate is absorbed at least partially by the liquid mixture of absorption agent and absorbate and is concentrated therein or is absorbed by the liquid absorbate-free absorption agent while forming a liquid mixture of absorption agent and absorbate. It is characteristic in the method in accordance with the present invention that the absorption agent used and the absorbate used have a miscibility gap.

The method in accordance with the invention is in particular suitable for the ecologically advantageous stripping of hydrocarbons (HCs) from gas mixtures by absorption and/or adsorption, wherein the HC or HCs form binary and ternary liquid mixtures or liquid mixtures of a higher phase in combination with a suitable solvent and the phase low in absorbates and/or low in adsorbates is recirculated.

### BACKGROUND

Different processes are used in the stripping of HCs from gases in which the HCs are separated or rendered harmless for recovery. The recovery of HCs is particularly desirable for economic and ecological reasons in the case of more complex HCs.

HCs contained in exhaust gases can be supplied to combustion, whereby as a rule the focus is on the elimination of harmful substances and simultaneously the calorific value of the HCs can be thermally used. In addition to the condensation or sublimation of gaseous HCs, screening and filtering processes are also used to precipitate HCs in solid form or as droplets. Furthermore, HCs contained in gases can be precipitated by membrane processes, adsorbed at solids or liquids or absorbed in solvents. Absorption processes are inter alia described in the patent literature in which absorption agents are used which absorb the volatile substance and release it to another subsequently admixed substance so that the absorption agent becomes available again for a new absorption.

It is, however, disadvantageous in this process that a substance once absorbed by an absorption agent has to be “liberated” from this absorption agent again by addition of a further substance. This is uneconomical, on the one hand, since further additional substances have to be used; on the other hand, a complete removal of the substance to be absorbed (absorbate) is equally not ensured.

### SUMMARY

It is therefore the object of the present invention to provide a simple, economically and ecologically particularly suitable method for stripping absorbates from gas mixtures containing absorbate.

This object is satisfied by the features of claim 1, with the dependent claims representing advantageous further developments.

In accordance with the invention, a method of removing an absorbate from gases or gas mixtures containing absorbate, in which the gas or gas mixture is contacted by a liquid mixture of absorption agent and absorbate or of liquid absorbate-free absorption agent, wherein the absorbate is absorbed at least partially by the liquid mixture of absorption agent and absorbate and is concentrated therein or is absorbed by the liquid absorbate-free absorption agent while forming a liquid mixture of absorption agent and absorbate. It is characteristic in the method in accordance with the present invention that the absorption agent used and the absorbate used have a miscibility gap.

In accordance with the invention, a substance is understood by the term “absorbate” which is present in gaseous form or as an aerosol in gases or gas mixtures and which is to be stripped from the gas or gas mixtures. The stripping in accordance with the invention in this respect takes place by means of absorption by means of an absorption agent.

A region of a binary, ternary or multiphase mixture of absorption agent and at least one absorbate is understood as the miscibility gap in that a conditional miscibility between the absorption agent and the absorbate is present, i.e. at least two separate phases are present, namely a high-absorbate phase and a low-absorbate phase.

In a preferred embodiment, the absorbate is a hydrocarbon and the absorption agent is a solvent, with the system of absorbate (hydrocarbon) and absorption agent (solvent) having a miscibility gap. Preferred systems of hydrocarbon/solvent are in this respect selected from the group comprising phenol/water, hexane/nitrobenzene, triethylamine/water, methyl vinyl ketone/water, octanol/water, acetaldehyde/vinyl acetate and nicotine/water.

The present invention is in particular suitable for stripping gaseous phenol and/or phenol aerosols from gases or gas mixtures containing phenol; in this process, water or a water/phenol mixture is used as the absorption agent.

A further preferred embodiment of the method in accordance with the invention provides that the mixture of absorption agent and absorbate is a phenol/water mixture having a weight ratio of phenol/water<75:25, preferably 0.01:99.99≦phenol/water≦70:30, further preferably 0.1:99.9≦phenol/water≦50:50, further preferably 1:99≦phenol/water≦10:90.

For the case that a mixture of absorbate and absorption agent is already being used for absorbing the absorbate from the gas or gas mixture containing absorbate, it is preferred if the mixing ratio between the absorbate and the absorption agent of the liquid mixture of absorbate and absorption agent in contact with the gas or gas mixture is selected such that a single-phase mixture rich in absorption agent is present (solution of absorbate in absorption agent).

It is furthermore advantageous if, after the contact of the liquid mixture of absorption agent and absorbate or of the liquid absorbate-free absorption agent with the gas or gas mixture containing absorbate and an at least partial absorption and concentration of the absorbate in the liquid mixture or in the liquid absorbate-free absorption agent, a separation of the resulting liquid mixture from the gas or gas mixture takes place, the separated liquid mixture is set to temperatures and pressures such that the liquid mixture is in the range of the miscibility gap, with a phase separation taking place into at least one high-absorbate and one low-absorbate phase and a phase separation of the high-absorbate and low-absorbate phase is carried out, with the phase separation preferably being carried out in a phase separator.

In addition, the present invention makes it possible to conduct the separated low-absorbate phase in a circuit and to contact it again with the gas or gas mixture. In this respect, a recovery of the absorption agent from the high-absorbate phase can take place, in particular by distillation, rectification, precipitation, electrolysis, membrane separation processes or crystallization. To this extent, an extremely economically and ecologically advantageous process formation is ensured.

It is furthermore advantageous if the low-absorbate phase conducted in a circuit is charged with fresh absorption agent and/or absorption agent recovered by separating the absorption agent from the high-absorbate phase before or during the contact with the gas or gas mixture.

A further preferred embodiment of the method in accordance with the invention provides that the gas or gas mixture includes at least one further substance which forms at least one separate phase with the liquid mixture of absorbate and absorption agent or the liquid absorbate-free absorption agent and which on contact with the liquid mixture or liquid absorbate-free absorption agent is separated at least partially from the gas or gas mixture simultaneously with the absorbate and is concentrated in the liquid mixture or is absorbed in the liquid absorbate-free absorption agent while forming a liquid mixture of absorption agent and absorbate. This substance can be separated by phase separation, in particular in a phase separator, after separation of the resulting liquid mixture from the gas or gas mixture. The at least one further substance is preferably selected from the group comprising oils and/or fats. Subsequent to or simultaneously with the phase separation, the liquid mixture is set to temperatures and pressures so that the liquid mixture is in the range of the miscibility gap, with a phase fractionation into a high-absorbate phase and a low-absorbate phase taking place and a phase separation into a high-absorbate phase and a low-absorbate phase being carried out. In this process, the further substance is separated by forming a further separate phase.

It is equally advantageous if the liquid mixture or liquid absorbate-free absorption agent has a temperature during the contacting and/or if the resulting liquid mixture has a temperature during the phase separation in the range from 0 and 60° C., preferably from 4 and 50° C., particularly preferably from 5 and 30° C., in particular from 6 to 15° C.

Additionally or alternatively hereto, it is equally possible that the gas or the gas mixture has a temperature during the contacting in the range from 0 to 400° C., preferably from 40 to 300° C.

The method in accordance with the invention is not subject to any limitation with respect to gases or gas mixtures to be used. The gases or gas mixtures are, however, advantageously selected from the group comprising nitrogen, oxygen, air, hydrogen, helium, carbon dioxide, ammonia, neon, argon, fluorine, chlorine, volatile hydrocarbons, C4 cutting gas, gaseous absorbate, gaseous absorption agent and/or gas mixtures resulting herefrom.

In a further advantageous embodiment, the contacting of the liquid mixture of absorption agent and absorbate or of the liquid absorbate-free absorption agent with the gas or gas mixture is carried out in a container, in an apparatus, in a tank, in a tubing, in a machine, in a column, in a column with or without installations, in a column having at least one separation stage, in a column having at least one packing, in a spray condenser, in a fall-film apparatus, in a trickle apparatus, in a jet apparatus, in a steam blaster, in a steam blast vacuum pump, in a liquid jet pump, in a liquid ring pump, in a saturator, in an atomizer, in a demister, in a filter, in an impregnated or moistened filter or at the surface of a membrane.

Columns with or without installations or a column having at least one separation stage are advantageously used; in this respect, the process management is preferably carried out such that the liquid mixture of absorption agent and absorbate or the liquid absorbate-free absorption agent is conducted in counterflow, in particular from top to bottom, to the gas or gas mixture.

It is further preferred if the gas or gas mixture originates from exhaust vapor of polymerization processes or polycondensation processes and/or from the blanketing of apparatus and/or from the evacuation of apparatus and/or from vaporization within apparatus or machines.

It is in particular preferred in this respect if the polycondensation processes are in particular selected from the group comprising melt-phase polycondensations carried out at pressures reduced with respect to normal conditions, in particular in the manufacture of polycarbonates, polyphosphates or copolymers of polycarbonates and polyphosphates, in which exhaust vapors including phenol arise.

The present invention will be explained in more detail with reference to the following statements and the enclosed Figures without restricting the invention to the embodiments shown.

It is known that a liquid mixture of phenol and water has a miscibility gap below the upper critical point of the solution. This means that such a mixture breaks down into two phases of different compositions provided that the averaged composition of the mixture is within the miscibility gap. It has been shown that with water-phenol mixtures a low-phenol (low-absorbate) phase recirculated at low temperatures, which means a preferred temperature range between 50° C. and 30° C., is exceptionally suitable for the absorption of phenol (absorbate) from gas mixtures and that in so doing a second, high-phenol phase is formed which can be separated easily and energy-efficiently by a phase separator. The phenol/water mixture furthermore allows the absorption and/or absorption and condensation of substances which do not dissolve or only slightly dissolve in the binary substance mixture. Further phases can thus be formed in addition to the two phases of the binary mixture.

The invention described here makes use of just this principle to remove HCs such as phenols or additives from gas mixtures on a technical scale and to allow an energetically favorable preparation, further processing or disposal. Unlike with conventionally used processes for stripping HC from gas mixtures, an absorption agent conducted in a circuit is used here for economic reasons which already contains the substance to be absorbed (absorbate) on the entry into the washing apparatus and forms a binary mixture with it, or a ternary mixture or a mixture of a higher phase on the presence of substances which only have a low solubility with the absorption agent or absorbate.

The substances to be absorbed are preferably brought into contact with the low-absorbate phase of the binary mixture. The washing liquid is concentrated with the substance to be absorbed, for example a hydrocarbon. Due to the miscibility gap between the absorbate and the absorption agent, a phase separation occurs, a binary mixture between the charged and the low-absorbate phase. In addition, further substances such as oils, which have a low solubility with the two phases of the binary mixture, can be condensed and/or absorbed or adsorbed by the two phases of the binary mixture. In such a constellation, substance mixtures with three and more phases are formed. The binary or ternary mixtures or mixtures of a higher-phase can be separated with a minimal energetic effort by means of phase separators. The phase of the binary mixture can subsequently be separated by conventional technical process measures such as distillation, rectification, precipitation, electrolysis, membrane separation processes or crystallization.

It is equally possible to contact the substances to be absorbed with the high-absorbate phase.

In the case of a thermal exploitation, the increased ratio of HC favors the high-absorbate phase, in particular on the use of aqueous solvents, since in the ideal case less or no co-firing would be needed. The low-absorbate phase conducted in a circuit is again supplied to the gas washing apparatus after separating the high-absorbate phase. Supplementation takes place by absorption medium expelled with the high-absorbate phase - ideally the absorption agent recovered from the separation of the high-absorbate phase is utilized.

In addition to the energetically favorable gas purification and substance separation, the liquid phases can be used in other parts of the process. DE 10 2005 018 843 A1 writes on the operation of steam jet vacuum pumps in the area of polycondensation in the polycarbonate process “However, this creates a significant environmental problem, namely, the production of large quantities of wastewater contaminated with phenols, dialcohols, and oligomers, for example”.

The utilization of the miscibility gap thus allows the use of substance mixtures of phenol and water for operating e.g. steam jet vacuum pumps, liquid jet pumps, liquid ring pumps or also of spray condensers.

Depending on the application, the (high-absorbate) phase containing up to approx. 75% phenol or the (low-absorbate) phase containing up to 94% water could be utilized within the framework of the process. At the same time, the method allows oil vapors contained in the gas to condense and oil droplets to adsorb such as can occur on the use of mechanical vacuum pumps. The oil is separated as a third phase in the case of a mixture of phenol and water in the phase separator. The oil phase can be separated, treated and returned to the oil circuit. On the use of pumps fed with a ballast gas a treatment can be dispensed with depending on the purity and on the return quantity of the oil.

The technical use of this invention in particular extends to those technical process areas in which a miscibility gap occurs between an absorbate to be absorbed from a gas, e.g. a hydrocarbon (HC), and its absorption agent or an HC to be removed from a gas is to be adsorbed and/or condensed by means of a liquid absorption medium and at least one phase of the recirculated gas washing liquid is again supplied to gas washing or to another part of the process as an additive, a lubricant or process medium. Processes can in particular profit in which recoverable, environmentally harmful or toxic HCs arise as products, byproducts or co-products. In particular phenol classified as toxic, hazardous to the health and corrosive can be named here. Phenol is a significant bulk chemical which is used for the synthesis of numerous substances. It can be found as a starting material, product, byproduct or co-product in the petrochemical industry, textile industry, pharmaceutical industry and in the plastic industry. On the manufacture of polycondensates such as polycarbonates, polyphosphonates and their copolymers by melt-phase polycondensation, phenol occurs in the gas phase as a coproduct which is extracted via exhaust vapor lines through the vacuum system. The method described here can be used to purify the exhaust gases exiting the vacuum system. In this process, the miscibility gap of a phenol/water mixture is utilized which occurs between approximately 4° C. and the critical point at approximately 67° C. The miscibility gap extends over a range from approximately 6% by weight to 75% by weight phenol portion. To keep the vapor pressure of the phenol low within the framework of exhaust gas purification, a temperature of 5° C. to 30° C. is preferably selected. As the temperature drops, the phase separation speed falls, while the concentration of the phases is displaced further toward the pure substances. It has proved to be advantageous to aim for temperatures between 6° C. and 15° C. for the phase separation. The low-phenol washing liquid (phenol portion of around 6% phenol) is brought into contact with the exhaust gas containing phenol due to the temperature. It proves advantageous in this respect to conduct the washing liquid from the top to the bottom in counterflow to the exhaust gas through a column provided with a packing. The efficiency of the process was demonstrated in operation of a trial plant for manufacturing polyphosphonates since the phenol portion contained in the exhaust gas can be reduced from around 6000 ppm to around 30 ppm (washing liquid temperature 12° C.). In addition to the two phases of the binary mixture of phenol and water, a third phase is formed which comprises the vacuum pump oil of a rotary vane pump used within the framework of the process. Due to its insensitivity to moisture and phenol (constant ballast gas flow), the oil can again be supplied to the pump while taking account of the moisture of the operating oil permitted for the pump.

### BRIEF DESCRIPTION OF THE DRAWINGS

FIG. 1 shows an arrangement with which the method in accordance with the invention can be carried out. The arrangement shown in FIG. 1 will be explained with reference to the example of the separation of phenol from gases or gas mixtures containing phenol by means of water or by means of a low-phenol phase of a phenol/water mixture.

### DETAILED DESCRIPTION

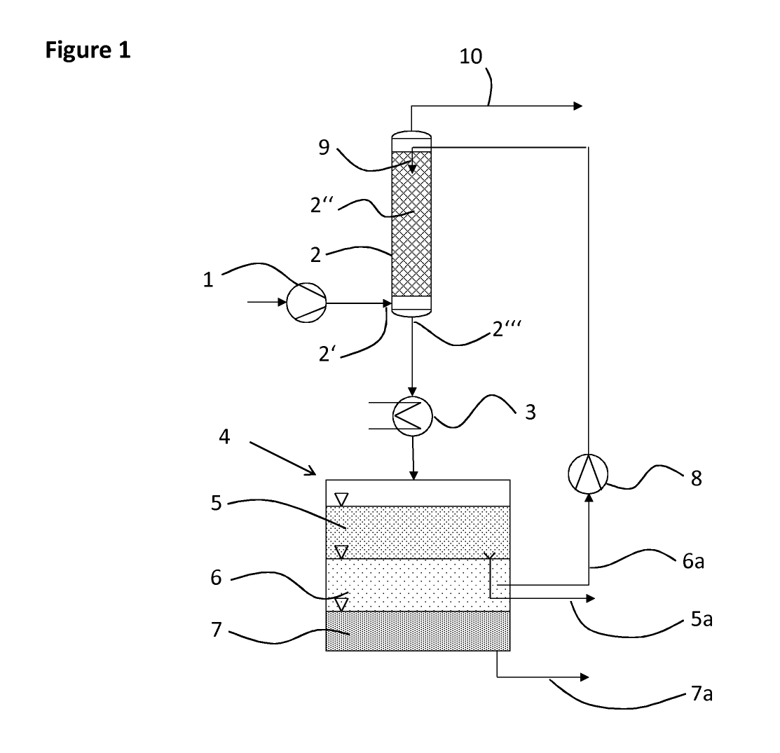

The separation of the phenol from the gases or gas mixtures by absorption takes place by means of a column 2 in accordance with FIG. 1. The gases or gas mixtures can originate from process exhaust gases, for example from reaction apparatus 1 upstream of the column 2. The process exhaust gases resulting therefrom are supplied to the column 2 via an inlet 2′. The column 2 has installations 2″ or means to increase the surface such as grids or packed beds, etc. to improve the contacting of the absorption agent with the gases or gas mixtures. The absorption agent, for example the low-phenol phase of a phenol/water mixture is supplied to the column 2 from above via an inlet 9 so that the liquid absorption agent can, for example, be trickled into the column 2. The gas or gas mixture is thus conducted to the absorption agent in counterflow.

The purified or low-absorbate gas flow is taken up at the head of the column 2 via an outlet 10. The absorbate falling from the top to the bottom is collected at the base of the column 2, is removed via an outlet 2′″ and is supplied to a phase separator 4. For example, means for the temperature setting of the absorbate-concentrated absorption means such as a heat exchanger 3 can be attached between the column 2 and the phase separator 4. A separation into a high-absorbate, i.e. high-phenol, phase 7 of a phenol/water mixture and into a low-absorbate phase 7, i.e. a low-phenol phase 6, of a phenol/water mixture 7 or 6 respectively takes place in the phase separator 4. For the case that oils or other hydrocarbons are simultaneously washed out of the gases or gas mixtures, a further oil phase is 5 is formed. The respective phases 5, 6, 7 are removed from the phase separator via corresponding outlets 5a, 6a, 7a. The high-phenol phase 7 is recovered for further use; it can, for example, be the separation of the water portion from the high-phenol phenol/water phase and thus the acquisition of pure phenol. The low-phenol phase 6 is, for example, recirculated via a pump and again supplied to the column 2 for the repeat absorption of the absorbate from the gases or gas mixtures.

What is claimed is:

1. A method of removing an absorbate from a gas or gas mixture containing absorbate, in which the gas or gas mixture is contacted by a liquid mixture of absorption agent and absorbate or of liquid absorbate-free absorption agent, wherein the absorbate is absorbed at least partially by the liquid mixture of absorption agent and absorbate and is concentrated therein or is absorbed by the liquid absorbate-free absorption agent while forming a liquid mixture of absorption agent and absorbate, wherein the absorption agent and the absorbate have a miscibility gap.

2. The method in accordance with claim 1, wherein the system of absorbate/absorption agent having a miscibility gap is a system of a hydrocarbon absorbate and a solvent absorption agent having a miscibility gap.

3. The method in accordance with claim 2, wherein the hydrocarbon/solvent system is one of phenol/water, hexane/nitrobenzene, triethylamine/water, methyl vinyl ketone/water, octanol/water, acetaldehyde/vinyl acetate, or nicotine/water.

4. The method in accordance with claim 1, wherein the mixture of absorption agent and absorbate is a mixture of a hydrocarbon and a solvent, with the hydrocarbon/solvent mixture being a phenol/water mixture having a weight ratio of phenol/water<75:25.

5. The method in accordance with claim 1, wherein the mixing ratio between the absorbate and the absorption agent or of the liquid mixture of absorbate and absorption agent contacted by the gas or gas mixture is selected so that a single-phase high-absorption agent mixture or solution of absorbate in absorption agent is present.

6. The method in accordance with claim 1, wherein, after the contact of the liquid mixture of absorption agent and absorbate or of the liquid absorbate-free absorption agent with the gas or gas mixture containing absorbate and an at least partial absorption and concentration of the absorbate in the liquid mixture or in the liquid absorbate-free absorption agent, a separation of the resulting liquid mixture from the gas or gas mixture takes place, the separated liquid mixture is set to a temperature and pressure such that the liquid mixture is in the range of the miscibility gap, with a phase separation taking place into at least one high-absorbate and one low-absorbate phase and a phase separation of the high-absorbate and low-absorbate phase is carried out.

7. The method in accordance with claim 6, wherein the separated low-absorbate phase is conducted in a circuit and is again contacted with the gas or the gas mixture and/or the absorption agent is recovered from the high-absorbate phase, in particular by at least one of distillation, rectification, precipitation, electrolysis, membrane separation processes, or crystallization.

8. The method in accordance with claim 7, wherein the low-absorbate phase conducted in a circuit is charged with fresh absorption agent and/or absorption agent recovered by separating the absorption agent from the high-absorbate phase before or during the contact with the gas or gas mixture.

9. The method in accordance with claim 1, wherein the gas or gas mixture includes at least one further substance which forms at least one separate phase with the liquid mixture of absorbate and absorption agent or the liquid absorbate-free absorption agent and which on contact with the liquid mixture or liquid absorbate-free absorption agent is separated at least partially from the gas or gas mixture together with the absorbate and is concentrated in the liquid mixture or is absorbed in the liquid absorbate-free absorption agent while forming a liquid mixture of absorption agent and absorbate; is separated, after separation of the resulting liquid mixture from the gas or gas mixture by phase separation, in particular in a phase separator, with the at least one further substance being an oil and/or fat; subsequent to or simultaneously with the phase separation, the liquid mixture is set to a temperature and pressure so that the liquid mixture is in the range of the miscibility gap, with a phase separation into an high-absorbate phase and a low-absorbate phase being carried out.

10. The method in accordance with claim 1, wherein
a) the liquid mixture or liquid absorbate-free absorption agent has a temperature during the contacting and/or the resulting liquid mixture has a temperature during the phase separation in the range from 0 and 60° C.; and/or
b) the gas or the gas mixture has a temperature in the range from 0 to 400° C. during the contacting.

11. The method in accordance with claim 1, wherein the gas or the gas mixture is selected from the group consisting essentially of nitrogen, oxygen, air, hydrogen, helium, carbon dioxide, ammonia, neon, argon, fluorine, chlorine, volatile hydrocarbons, C4 cutting gas, gaseous absorbate, gaseous absorption agent, and/or a gas mixture resulting therefrom.

12. The method in accordance with claim 1, wherein the contacting of the liquid mixture of absorption agent and absorbate or of the liquid absorbate-free absorption agent with the gas or the gas mixture is carried out in a container, in an apparatus, in a tank, in a tubing, in a machine, in a column, in a column with or without installations, in a column having at least one separation stage, in a column having at least one packing, in a spray condenser, in a fall-film apparatus, in a trickle apparatus, in a jet apparatus, in a steam blaster, in a steam blast vacuum pump, in a liquid jet pump, in a liquid ring pump, in a saturator, in an atomizer, in a demister, in a filter, in an impregnated or moistened filter, or at the surface of a membrane.

13. The method in accordance with claim 12, wherein a column with or without installation or a column having at least one separation stage is used, with the liquid mixture of absorption agent and absorbate or the liquid absorbate-free absorption agent being conducted in counterflow, in particular from top to bottom, to the gas or gas mixture.

14. The method in accordance with claim 1, wherein the gas or gas mixture originates from exhaust vapor of a polymerization process or a polycondensation process and/or from the blanketing of apparatus and/or from the evacuation of an apparatus and/or from vaporization within an apparatus or machine.

15. The method in accordance with claim 14, wherein the polycondensation process is selected from the group consisting essentially of melt-phase polycondensation carried out at a pressure reduced with respect to normal conditions, in particular in the manufacture of a polycarbonate, polyphosphate, or a copolymer of a polycarbonate and a polyphosphate, in which exhaust vapor including phenol arises.
